(19) United States
(12) Patent Application Publication
(10) Pub. No.: US 2014/0174216 A1
(43) Pub. Date: Jun. 26, 2014

(54) ROTARY PLATFORM DEVICE

(71) Applicants: HON HAI PRECISION INDUSTRY CO., LTD., New Taipei (TW); Fu Tai Hua Industry (Shenzhen) Co., Ltd., Shenzhen (CN)

(72) Inventors: MU-RUI PENG, Shenzhen (CN); GANG-TAO FAN, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/014,421

(22) Filed: Aug. 30, 2013

(30) Foreign Application Priority Data
Dec. 26, 2012 (CN) 2012105713400

(51) Int. Cl. F16H 21/36

(52) U.S. Cl. CPC F16H 21/36
USPC 74/45

(57) ABSTRACT

A rotary platform device is for supporting and rotating an assembly. The rotary platform device includes a rotary platform and a casing. The rotary platform extends up from the casing. The casing accommodates a driving device, a coupling member, and a linkage bar. The driving device provides linear motion, which is translated by the linkage bar to rotary motion applied to the rotary platform.

### BACKGROUND

1. Technical Field

The present disclosure relates to a rotary platform device typically used for supporting and rotating an assembly undergoing manufacture.

2. Description of Related Art

During assembly of electronic devices such as cellular phones and tablet computers, rotation of the electronic device assembly is required such that glue can be applied to different positions of the electronic device assembly. Therefore, there is a need to provide a means to support and rotate the electronic device assembly.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a rotary platform device according to one embodiment.

FIG. 2 is an exploded view of the rotary platform device of FIG. 1.

FIG. 3 similar to FIG. 1, but with a rotary platform and a top plate of the rotary platform device omitted, in order to show internal elements thereof.

FIG. 4 is an isomeric view of certain of the internal elements of FIG. 3, but showing such elements inverted.

### DETAILED DESCRIPTION

Embodiments of the present disclosure will be described with reference to the accompanying drawings.

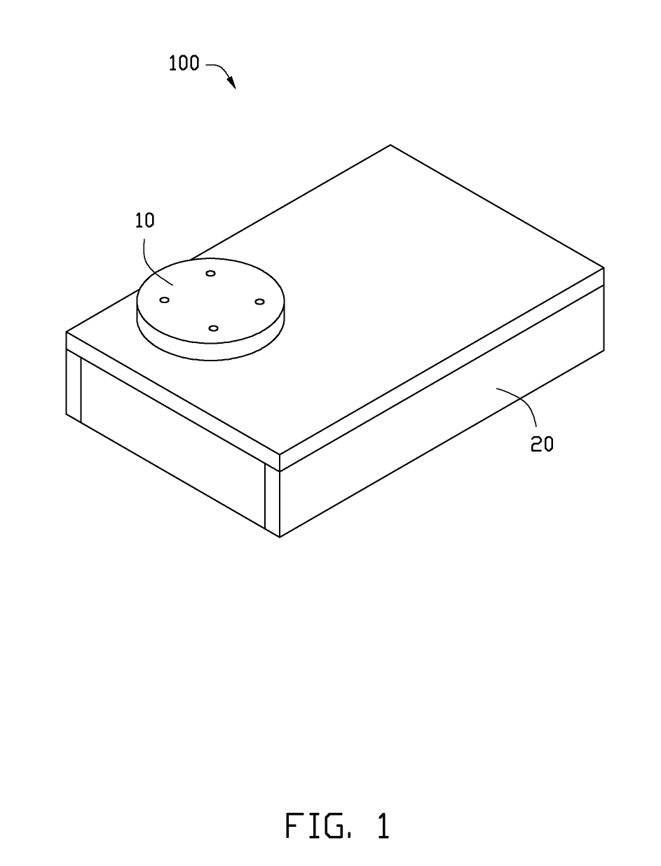

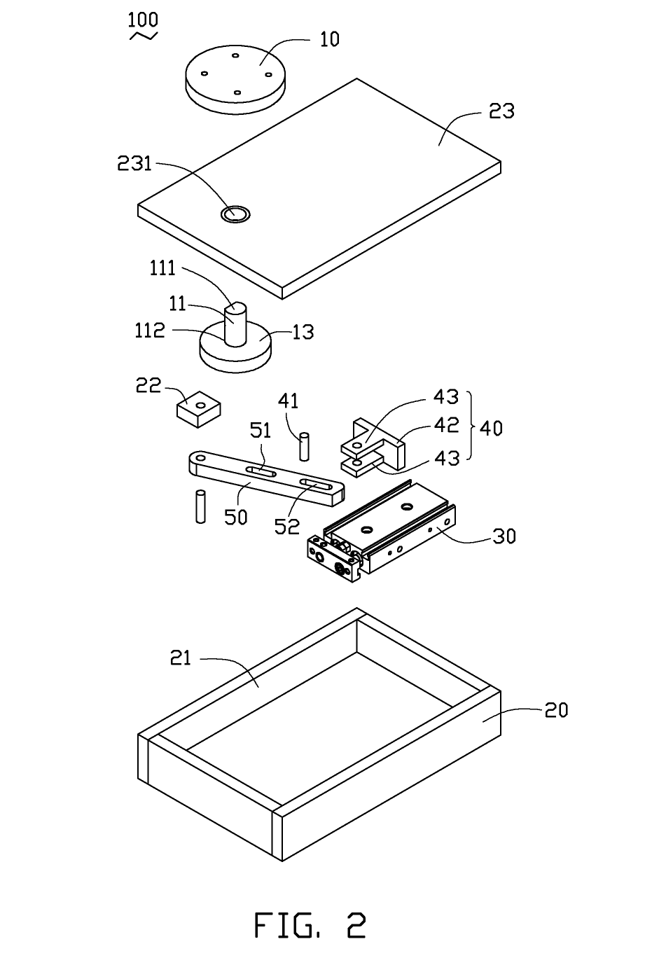

Referring to FIGS. 1-2, a rotary platform device 100 includes a rotary platform 10 and a casing 20. The rotary platform 10 is secured to a top end 111 of a shaft 11 that extends through a through hole 231 in a top plate 23 of the casing 20. The shaft 11 is rotatable with respect to the top plate 23, and rotatably connects the rotary platform 10 to the casing 20.

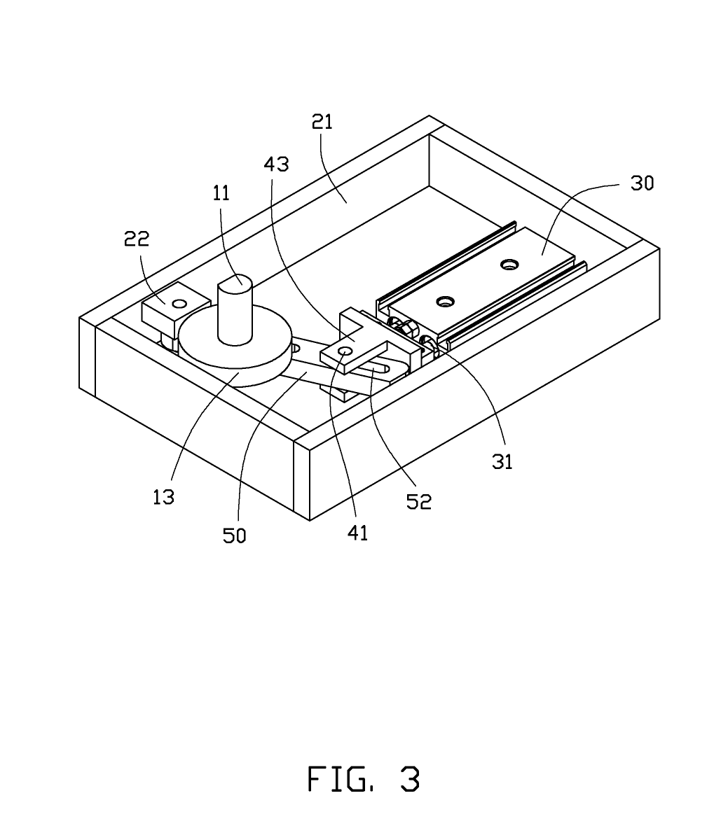

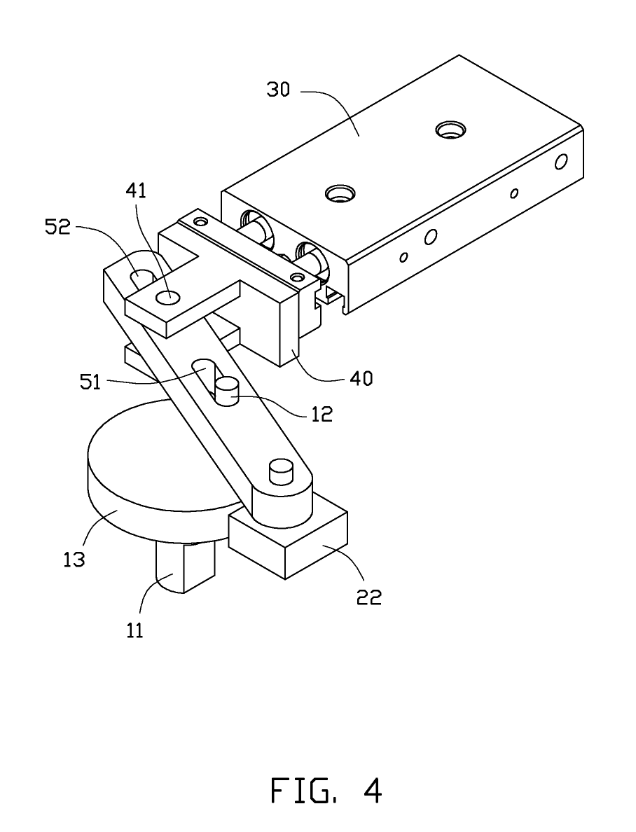

Referring to FIGS. 3-4, the rotary platform device 100 further includes a driving device 30, a coupling member 40 and a linkage bar 50. In the embodiment, a connecting member 13 is secured to a lower end 112 of the shaft 11. A pin 12 protrudes down from the connecting member 13 and is distanced from a rotational axis of the shaft 11. The pin 12 and the shaft 11 are located at opposite bottom and top sides of the connecting member 13, respectively. In the embodiment, the connecting member 13 is a round disc. In other embodiments, the connecting member 13 may be a rod with ends connected to the shaft 11 and the pin 12.

The driving device 30 (e.g., a linear motor or a pneumatic cylinder) is arranged within the casing 20, and includes a reciprocating rod 31 with linear motion. The coupling member 40 is secured to the end of the reciprocating rod 31. The linkage bar 50 is rotatably connected to the casing 20. The linkage bar 50 is movably connected to the connecting member 13 and the coupling member 40. The linkage bar 50 transfers the motion of the coupling member 40 to the connecting member 13, thereby causing the shaft 11 to rotate. The rotary platform 10 rotates with the shaft 11.

In the embodiment, the coupling member 40 includes a main body secured to the reciprocating rod 31, and a post 41 connected to the main body. The linkage bar 50 defines a first slot 51 and a second slot 52. The pin 12 is slidably received in the first slot 51, and the post 41 is slidably received in the second slot 52. The post 41 is used to push the linkage bar 50, and the linkage bar 50 is used to push the pin 12, thereby rotating the shaft 11.

In the embodiment, the main body includes a base 42 and two arms 43 protruding from the base 42. Opposite ends of the post 41 are secured to the two arms 43. The casing 20 includes a block 22 secured to an inner side of a sidewall 21. One end of the linkage bar 50 is rotatably connected to the block 22.

While various embodiments have been described and illustrated, the disclosure is not to be construed as being limited thereto. Various modifications can be made to the embodiments by those skilled in the art without departing from the true spirit and scope of the present disclosure as defined by the appended claims.

What is claimed is:

1. A rotary platform device comprising:
a rotary platform;
a casing comprising a top plate that defines a through hole;
a shaft extending through the through hole and being rotatable with respect to the top plate, the shaft comprising an upper end and a lower end, the rotary platform being secured to the upper end;
a connecting member secured to the lower end of the shaft;
a driving device secured to the casing and comprising a reciprocating rod;
a coupling member secured to the reciprocating rod; and
a linkage bar rotatably connected to the casing, the linkage bar being movably connected to the connecting member and the coupling member, the linkage bar configured to transfer motion of the coupling member to the connecting member, thereby causing the shaft to rotate.

2. The rotary platform device according to claim 1, further comprising a pin secured to the connecting member, wherein the coupling member comprises a main body secured to the reciprocating rod and a post connected to the main body, the linkage bar defines a first slot and a second a slot, the pin is slidably received in the first slot, the post is slidably received in the second slot, the post is configured to push the linkage bar, and the linkage bar is configured to push the pin, thereby causing the shaft to rotate.

3. The rotary platform device according to claim 2, wherein the main body comprises a base and two arms protruding from the base, the post is secured to the two arms.

4. The rotary platform device according to claim 1, wherein the driving device is a linear motor.

5. The rotary platform device according to claim 1, wherein the driving device is a pneumatic cylinder.

6. The rotary platform device according to claim 1, wherein the casing comprises a block, one end of the linkage bar is rotatably connected to the block.

7. The rotary platform device according to claim 2, wherein the shaft and the pin are located at opposite sides of the connecting member.
